(19) United States
(12) Patent Application Publication
(10) Pub. No.: US 2026/0279288 A1
(43) Pub. Date: Sep. 17, 2026

(54) SCAN DRIVING CIRCUITS AND ELECTRONIC DEVICES

(71) Applicant: Samsung Display Co., Ltd., Yongin-si (KR)

(72) Inventors: Jaeyong JANG, Yongin-si (KR); Ilnam KIM, Yongin-si (KR); Minkyu WOO, Yongin-si (KR); Minjae JEONG, Yongin-si (KR); Jaehyung CHO, Yongin-si (KR)

(73) Assignee: Samsung Display Co., Ltd., Yongin-si (KR)

(21) Appl. No.: 19/422,658

(22) Filed: Dec. 17, 2025

(30) Foreign Application Priority Data
Mar. 17, 2025 (KR) 10-2025-0034017

(51) Int. Cl. G09G 3/3266; G09G 3/3233

(52) U.S. Cl. CPC G09G 3/3266; G09G 3/3233; G09G 2300/0819; G09G 2300/0842; G09G 2300/0861; G09G 2310/08; G09G 2320/043

(57) ABSTRACT

A scan driving circuit of an electronic device includes a first inverter circuit configured to output a first signal to a first node in response to a carry input signal, a first clock signal and a second clock signal, and output a second signal to a second node, the second signal being obtained by inverting the carry input signal, a diode circuit configured to transmit the second signal of the second node to a third node in response to the first signal of the first node, and a second inverter circuit configured to output a scan signal and a carry output signal in response to a third signal of the third node, the scan signal and the carry output signal being complementary signals.

### CROSS-REFERENCE TO RELATED APPLICATIONS

This application claims priority under 35 U.S. C § 119 to Korean Patent Application No. 10-2025-0034017 filed on Mar. 17, 2025, in the Korean Intellectual Property Office, the disclosure of which is incorporated by reference herein in its entirety.

### BACKGROUND

The present disclosure relates to an electronic device for displaying an image.

An electronic device such as a television, a mobile phone, a tablet computer, a navigation system, a game machine, and/or the like, generates an image (or, a video) and provides the generated image to a user through a display screen.

The electronic device includes a plurality of pixels and driving circuits that control the plurality of pixels to display an image thereon. Each of the plurality of pixels includes a light-emitting element and transistors that control the light-emitting element.

A scan driver circuit, which is one of the driver circuits of the electronic device, may provide scan signals to the plurality of pixels.

### SUMMARY

Some example embodiments provide an electronic device including a scan driving circuit with improved driving performance.

According to an aspect of the present disclosure, a scan driving circuit includes a first inverter circuit configured to output a first signal to a first node in response to a carry input signal, a first clock signal and a second clock signal, and output a second signal to a second node, the second signal being obtained by inverting the carry input signal, a diode circuit configured to transmit the second signal of the second node to a third node in response to the first signal of the first node, and a second inverter circuit configured to output a scan signal and a carry output signal in response to a third signal of the third node, the scan signal and the carry output signal being complementary signals.

According to some example embodiments of the present disclosure, the diode circuit may include a first transistor connected between the second node and a first voltage terminal, the first transistor including a gate electrode connected to the first node, and a second transistor connected between the second node and the third node, the second transistor including a gate electrode connected to the first voltage terminal.

According to some example embodiments of the present disclosure, the first transistor may be an N-type transistor and the second transistor may be a P-type transistor.

According to some example embodiments of the present disclosure, the first inverter circuit may include a first transistor connected between a carry input terminal and the first node, the first transistor including a gate electrode connected to a first clock terminal configured to receive the first clock signal, and the carry input terminal is configured to receive the carry input signal, a second transistor connected between the carry input terminal and the first node, the second transistor including a gate electrode connected to a second clock terminal configured to receive the second clock signal, a third transistor connected between the second node and a first voltage terminal, the third transistor including a gate electrode connected to the first node, and a fourth transistor connected between a second voltage terminal and the second node, the fourth transistor including a gate electrode connected to the first node.

According to some example embodiments of the present disclosure, the first clock signal and the second clock signal may be complementary signals.

According to some example embodiments of the present disclosure, each of the second transistor and the third transistor may be an N-type transistor, and each of the first transistor and the fourth transistor may be a P-type transistor.

According to some example embodiments of the present disclosure, the second inverter circuit may include a first transistor connected between a first voltage terminal and an output terminal, the first transistor including a gate electrode connected to the first node, and the output terminal being configured to output the scan signal, a second transistor connected between the output terminal and a second voltage terminal, the second transistor including a gate electrode connected to the third node, a third transistor connected between the first voltage terminal and a carry output terminal, the third transistor including a gate electrode connected to the third node, and the carry output terminal being configured to output the carry output signal, and a fourth transistor connected between the carry output terminal and a third voltage terminal, the fourth transistor including a gate electrode connected to the third node.

According to some example embodiments of the present disclosure, each of the first transistor, the second transistor and the third transistor may be a P-type transistor, and the fourth transistor may be an N-type transistor.

According to some example embodiments of the present disclosure, the second inverter circuit may include a first transistor connected between a first voltage terminal and an output terminal, the first transistor including a gate electrode connected to the first node, and the output terminal being configured to output the scan signal, a second transistor connected between the output terminal and a second voltage terminal, the second transistor including a gate electrode connected to the third node, a third transistor connected between the first voltage terminal and a carry output terminal, the third transistor including a gate electrode connected to the second node, and the carry output signal being configured to output the carry output signal, and a fourth transistor connected between the carry output terminal and a third voltage terminal, the fourth transistor including a gate electrode connected to the second node.

According to some example embodiments of the present disclosure, each of the first transistor, the second transistor and the third transistor may be a P-type transistor, and the fourth transistor may be an N-type transistor.

According to some example embodiments of the present disclosure, the second inverter circuit may include a first transistor connected between a first voltage terminal and an output terminal, the first transistor including a gate electrode connected to the first node, and the output terminal being configured to output the scan signal, a second transistor connected between the output terminal and a first clock terminal, the second transistor including a gate electrode connected to the third node, and the first clock terminal being configured to receive the first clock signal, a third transistor connected between the first voltage terminal and a carry output terminal, the third transistor including a gate electrode connected to the third node, and the carry output terminal being configured to output the carry output signal, and a fourth transistor connected between the carry output terminal and a second voltage terminal, the fourth transistor including a gate electrode connected to the third node.

According to some example embodiments of the disclosure, each of the first transistor, the second transistor and the third transistor may be a P-type transistor, and the fourth transistor may be an N-type transistor.

An electronic device according to an aspect of the present disclosure includes a display module configured to display an image, and processing circuitry configured to transmit an electrical signal to the display module, the display module including a display panel including pixels connected to a scan line, and a scan driving circuit configured to output a scan signal to the scan line in response to a carry input signal, a first clock signal and a second clock signal, the scan driving circuit including a first inverter circuit configured to output a first signal to a first node in response to the carry input signal, the first clock signal and the second clock signal, and output a second signal to a second node, the second signal being obtained by inverting the carry input signal, a diode circuit configured to transmit the second signal of the second node to a third node in response to the first signal of the first node, and a second inverter circuit configured to output the scan signal in response to a third signal of the third node, the carry input signal and the scan signal being complementary signals.

According to some example embodiments of the present disclosure, the diode circuit may include a first transistor connected between the second node and a first voltage terminal, the first transistor including a gate electrode connected to the first node, and a second transistor connected between the second node and the third node, the second transistor including a gate electrode connected to the first voltage terminal.

According to some example embodiments of the present disclosure, the first transistor may be an N-type transistor and the second transistor may be a P-type transistor.

According to some example embodiments of the disclosure, the first inverter circuit may include a first transistor connected between a carry input terminal and the first node, the first transistor including a gate electrode connected to a first clock terminal, the carry input terminal being configured to receive the carry input signal, and the first clock terminal being configured to receive the first clock signal, a second transistor connected between the carry input terminal and the first node, the second transistor including a gate electrode connected to a second clock terminal configured to receive the second clock signal, a third transistor connected between the second node and a first voltage terminal, the third transistor including a gate electrode connected to the first node, and a fourth transistor connected between a second voltage terminal and the second node, the fourth transistor including a gate electrode connected to the first node.

According to some example embodiments of the present disclosure, the second inverter circuit may include a first transistor connected between a first voltage terminal and an output terminal, the first transistor including a gate electrode connected to the first node, and the output terminal being configured to output the scan signal, and a second transistor connected between the output terminal and a second voltage terminal, the second transistor including a gate electrode connected to the third node.

According to some example embodiments of the present disclosure, the second inverter circuit may include a third transistor connected between the first voltage terminal and a carry output terminal, the third transistor including a gate electrode connected to the third node, and the carry output terminal being configured to output a carry output signal, and a fourth transistor connected between the carry output terminal and a third voltage terminal, the fourth transistor including a gate electrode connected to the third node.

According to some example embodiments of the present disclosure, the second inverter circuit may include a first transistor connected between a first voltage terminal and an output terminal, the first transistor including a gate electrode connected to the first node, and the output terminal being configured to output the scan signal, a second transistor connected between the output terminal and a second voltage terminal, the second transistor including a gate electrode connected to the third node, a third transistor connected between the first voltage terminal and a carry output terminal, the third transistor including a gate electrode connected to the second node, and the carry output terminal being configured to output a carry output signal, and a fourth transistor connected between the carry output terminal and a third voltage terminal, the fourth transistor including a gate electrode connected to the second node.

According to some example embodiments of the present disclosure, the second inverter circuit may include a first transistor connected between a first voltage terminal and an output terminal, the first transistor including a gate electrode connected to the first node, and the output terminal being configured to output the scan signal, a second transistor connected between the output terminal and a first clock terminal, the second transistor including a gate electrode connected to the third node, and the first clock terminal being configured to receive the first clock signal, a third transistor connected between the first voltage terminal and a carry output terminal, the third transistor including a gate electrode connected to the third node, and the carry output terminal being configured to output a carry output signal, and a fourth transistor connected between the carry output terminal and a second voltage terminal, the fourth transistor including a gate electrode connected to the third node.

The scan driver circuit of the electronic device which has one or more of the features described above, may turn on the output transistor sufficiently by providing a sufficiently low voltage to the Q node. As a result, the scan signal output from the scan driving circuit may be output at a stable low level. Therefore, a degradation of display quality of the image (or, video) displayed on the electronic device may be prevented or reduced.

### BRIEF DESCRIPTION OF THE DRAWINGS

FIG. 1 is a block diagram of an electronic device according to some example embodiments of the present disclosure.

FIG. 2 is a schematic diagram of an electronic device according to some example embodiments of the present disclosure.

FIG. 3 is a block diagram of a display module according to some example embodiments of the present disclosure.

FIG. 4 is a circuit diagram of a pixel according to some example embodiments of the present disclosure.

FIG. 5 is a block diagram exemplarily illustrating the first scan driving circuit illustrated in FIG. 3.

FIG. 6 is a circuit diagram of a first scan driving circuit according to some example embodiments of the present disclosure.

FIG. 7 is a timing diagram of signals used in the first scan driving circuit illustrated in FIG. 6.

FIG. 8 is a diagram exemplarily illustrating a first scan driving circuit according to some example embodiments of the present disclosure.

FIG. 9 is a diagram exemplarily illustrating a third scan driving circuit according to some example embodiments of the present disclosure.

### DETAILED DESCRIPTION

As used herein, it will be understood that when a component (or region, layer, portion, etc.) is referred to as being “on,” “connected,” or “coupled to” another component, it may be directly disposed, connected, or coupled to the other component or intervening component may be positioned therebetween. When one component is described herein as being “directly on,” “directly connected to,” or “directly coupled to” another component, it will be understood that no intervening component is positioned between the components.

Like reference numerals refer to like elements. In addition, in the drawings, the thicknesses, ratios, and dimensions of the component may be exaggerated to effectively describe the technical content. The term “and/or” includes any and all combinations definable by the associated configurations.

The terms “first,” “second,” etc. may be used to describe various components, but the components should not be limited to the terms. The terms are used only for the purpose of distinguishing one component from another. For example, a first component may be termed a second component, and similarly a second component may also be termed a first component, without departing from the scope of the present disclosure. The singular forms “a,” “an,” and “the” include plural forms unless the singular form is apparent from a context in which the terms appear.

In addition, the terms “below,” “beneath,” “above,” “on top,” and/or the like are used to describe the association of the configurations illustrated in the figures. The terms are described in relative terms, with reference to the directions indicated in the drawings. For example, if a configuration illustrated in the figures is turned over, elements described as “below” or “beneath” other elements or features would then be oriented “above” the other elements or features. Thus, the term “below” may encompass both an orientation of above and below. The configurations may be otherwise oriented (rotated 90 degrees or at other orientations) and the spatially relative descriptors used herein interpreted accordingly.

It will be understood that the terms “comprise”, “have,” and/or the like, re intended to designate the presence of a feature, number, operation, component, part, or combination thereof used herein, and does not preclude the presence or possibility of an additional of one or more other features or numbers, operations, components, parts, or combinations thereof.

Unless defined otherwise, all terms (including technical and scientific terms) used herein have the same meaning as, or a similar meaning to, that commonly understood by the persons ordinarily skilled in the art to which the present disclosure belongs. In addition, terms like those defined in commonly used dictionaries should be interpreted as having a meaning consistent with that in the context of the relevant art, and should not be interpreted in an overly idealized or overly formal sense unless explicitly defined herein.

Hereinafter, some example embodiments of the present disclosure will be described with reference to the drawings.

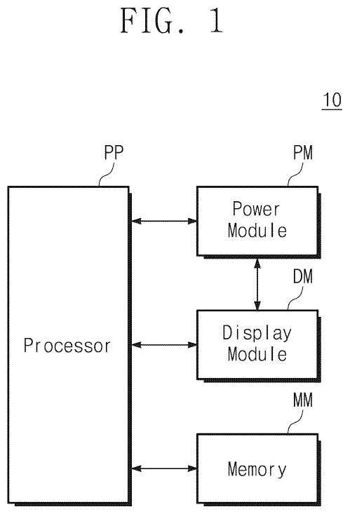

FIG. 1 is a block diagram of an electronic device 10 according to some example embodiments.

Referring to FIG. 1, an electronic device 10 according to some example embodiments may include a display module DM, a processor PP, a memory MM, and/or a power supply module PM.

According to some example embodiments, operations described herein as being performed by the processor PP may be performed by processing circuitry. The term “processing circuitry,” as used in the present disclosure, may refer to, for example, hardware including logic circuits; a hardware/software combination such as a processor executing software; or a combination thereof. For example, the processing circuitry more specifically may include, but is not limited to, a central processing unit (CPU), an application processor (AP), a graphics processing unit (GPU), a communication processor (CP), an image signal processor (ISP), a controller, an arithmetic logic unit (ALU), a digital signal processor, a microcomputer, a field programmable gate array (FPGA), a System-on-Chip (SoC), a programmable logic unit, a microprocessor, and application-specific integrated circuit (ASIC), etc.

The software may comprise an ordered listing of executable instructions for implementing logical functions, and may be embodied in any “processor-readable medium” for use by or in connection with an instruction execution system, apparatus, or device, such as a single or multiple-core processor or processor-containing system. The software may be stored on or transmitted over as one or more instructions or code on a tangible, non-transitory computer-readable medium (e.g., the memory MM).

The memory MM may store data information necessary (or otherwise, used) for the operation of the processor PP and/or the display module DM. When the processor PP executes an application stored in the memory MM, an electrical signal (e.g., an image data signal and/or an input control signal) is transmitted to the display module DM, and the display module DM may process the received signal and output image information through a display screen. According to some example embodiments, the memory MM may be implemented by Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of non-transitory computer-readable storage medium known in the art.

The power supply module PM may include a power supply module such as a power adapter, a battery device or the like, and a power conversion module that converts power supplied by the power supply module to generate power required (or otherwise, used) for operation of the electronic device 10.

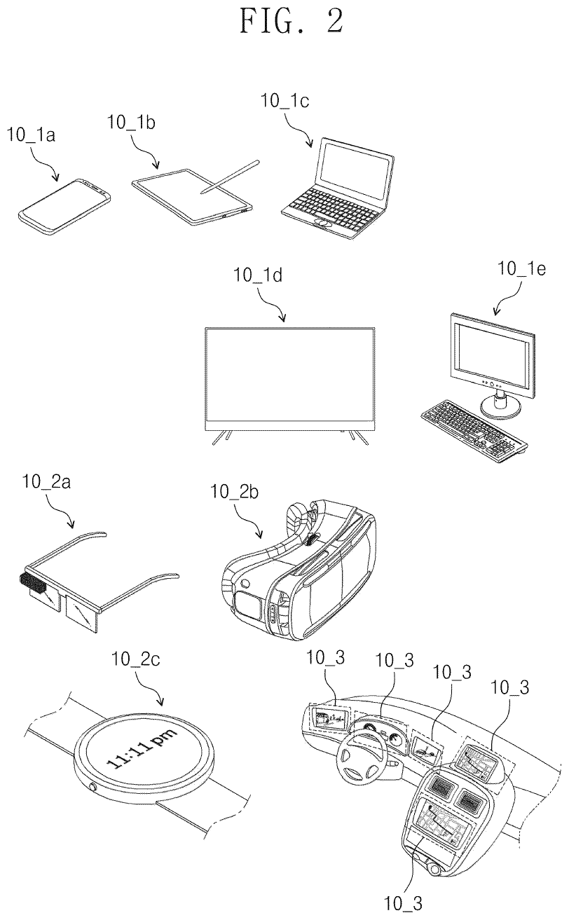

FIG. 2 is a schematic diagram of an electronic device according to some example embodiments.

Referring to FIG. 2, various electronic devices according to some example embodiments may include an electronic device for displaying an image such as a smartphone 10_1a, a tablet personal computer (PC) 10_1b, a laptop 10_1c, a television (TV) 10_1d, a desk monitor 10_1e and/or the like, as well as a wearable electronic device including a display module such as smart glasses 10_2a, a head mounted display 10_2b, a smart watch 10_2c, and/or the like, an electronic device for a vehicle including one or more display modules 10_3, such as a CID (Center Information Display), a room mirror display, and the like disposed on an instrument panel, a center fascia, and a dashboard of a vehicle, and/or the like.

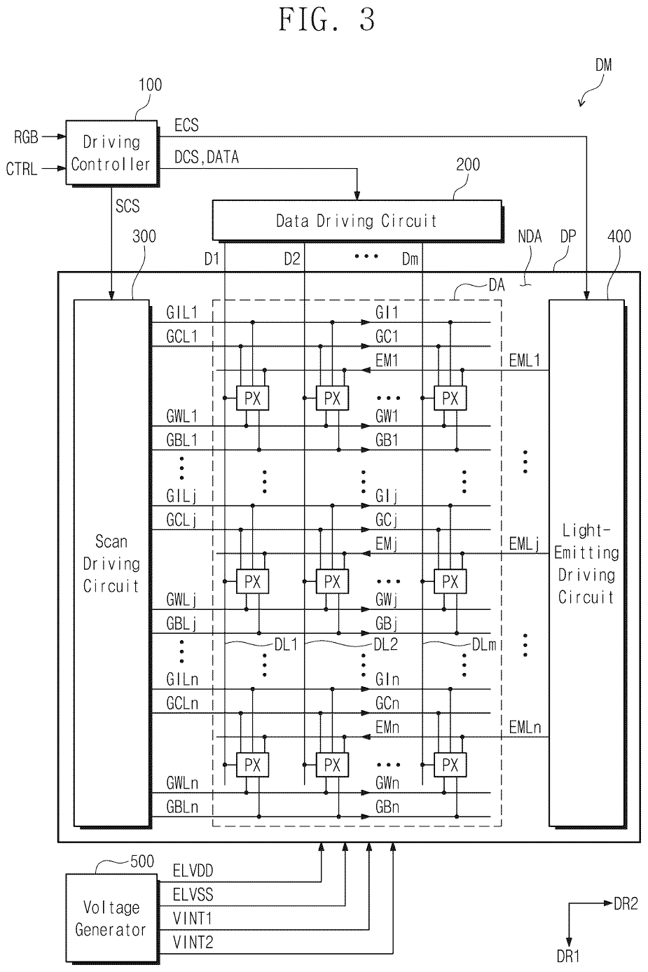

FIG. 3 is a block diagram of a display module DM according to some example embodiments of the present disclosure.

Referring to FIG. 3, the display module DM includes a display panel DP, a driving controller 100, a data driving circuit 200, a scan driving circuit 300, a light-emitting driving circuit 400, and/or a voltage generator 500. According to some example embodiments, operations described herein as being performed by the driving controller 100, the data driving circuit 200, the light-emitting driving circuit 400, and/or the voltage generator 500 may be implemented using processing circuitry.

The driving controller 100 receives the input image signal RGB and the control signal CTRL. In some example embodiments, the input image signal RGB and the control signal CTRL may be provided from the processor PP illustrated in FIG. 1. The driving controller 100 outputs an output image signal DATA, a scan control signal SCS, a data control signal DCS, and a light emission control signal ECS corresponding to the input image signal RGB and the control signal CTRL.

The data driving circuit 200 (scan driving circuits may also be referred to herein as scan driver circuits) receives the data control signal DCS and the output image signal DATA from the driving controller 100. The data driving circuit 200 converts the output image signal DATA into data signals D1-Dm, and outputs the data signals D1-Dm to a plurality of data lines DL1-DLm to be described below. The data signals are analog voltages corresponding to a grayscale value of the output image signal DATA.

The scan driving circuit 300 is arranged on a first side of the display panel DP. Scan lines GIL1-GILn, GCL1-GCLn, GWL1-GWLn, and GBL1-GBLn extend from the scan driving circuit 300 in a second direction DR2.

The scan driving circuit 300 receives the scan control signal SCS from the driving controller 100. The scan driving circuit 300 may output the scan signals GI1-GIn, GC1-GCn, GW1-GWn, and GB1-GBn to the scan lines GIL1-GILn, GCL1-GCLn, GWL1-GWLn, and GBL1-GBLn in response to the scan control signal SCS.

The light-emitting driving circuit 400 is arranged on a second side of the display panel DP. Light emission control lines EML1-EMLn extend from the light-emitting driving circuit 400 in a direction opposite to the second direction DR2.

The light-emitting driving circuit 400 receives the light-emitting control signal ECS from the driving controller 100. The light-emitting driving circuit 400 may output light-emitting signals EM1-EMn to the light emission control lines EML1-EMLn in response to the light-emission control signal ECS.

In the example illustrated in FIG. 3, the scan driving circuit 300 and the light-emitting driving circuit 400 are arranged facing each other with the display area DA in which the pixels PX are arranged interposed therebetween, but the present disclosure is not limited thereto. For example, the scan driving circuit 300 and the light-emitting driving circuit 400 may be disposed adjacent to each other on either the first side or the second side of the display panel DP. In some example embodiments, the scan driving circuit 300 and the light-emitting driving circuit 400 may be configured as one circuit (e.g., may both be integrated into a single circuit). In some example embodiments, each of the scan driving circuit 300 and the light-emitting driving circuit 400 is not disposed in the display panel DP and may be configured as a separate integrated circuit.

The voltage generator 500 generates voltages required (or otherwise, used) for operation of the display panel DP. In some example embodiments, the voltage generator 500 generates a first driving voltage ELVDD, a second driving voltage ELVSS, a first initialization voltage VINT1, and a second initialization voltage VInt2.

The display panel DP includes a display area DA and a non-display area NDA. The display panel DP may include pixels PX disposed on the display area DA. In some example embodiments, the scan driving circuit 300 and the light-emitting driving circuit 400 may be disposed on the non-display area NDA of the display panel DP.

The display panel DP includes the scan lines GIL1-GILn, GCL1-GCLn, GWL1-GWLn, and GBL1-GBLn, the light emission control lines EML1-EMLn, the data lines DL1-DLm, and the pixels PX.

The scan lines GIL1-GILn, GCL1-GCLn, GWL1-GWLn, and GBL1-GBLn extend from the scan driving circuit 300 in the second direction DR2 and are arranged to be spaced apart from each other in the first direction DR1. Each of the light emission control lines EML1-EMLn extends from the light-emitting driving circuit 400 in a direction opposite to the second direction DR2 and is arranged to be spaced apart from each other in the first direction DR1. The data lines DL1-DLm extend from the data driving circuit 200 in the first direction DR1 and are arranged to be spaced apart from each other in the second direction DR2. According to some example embodiments, the first direction DR1 may be orthogonal to the second direction DR2.

The plurality of pixels PX are electrically connected to the scan lines GIL1-GILn, GCL1-GCLn, GWL1-GWLn, GBL1-GBLn, the light emission control lines EML1-EMLn, and the data lines DL1-DLm, respectively. In some example embodiments, each of the plurality of pixels PX may be electrically connected to four scan lines and one light emission control line. For example, as shown in FIG. 3, the pixels of the first row may be connected to the scan lines GIL1, GCL1, GWL1, and GBL1 and the light emission control line EML1. In addition, the pixels of the j-th row may be connected to the scan lines GILj, GCLj, GWLj, and GBj and the light emission control line EMLj. The pixels of the n-th row may be connected to the scan lines GILn, GCLn, GWLn, and GBLn and the light emission control line EMLn.

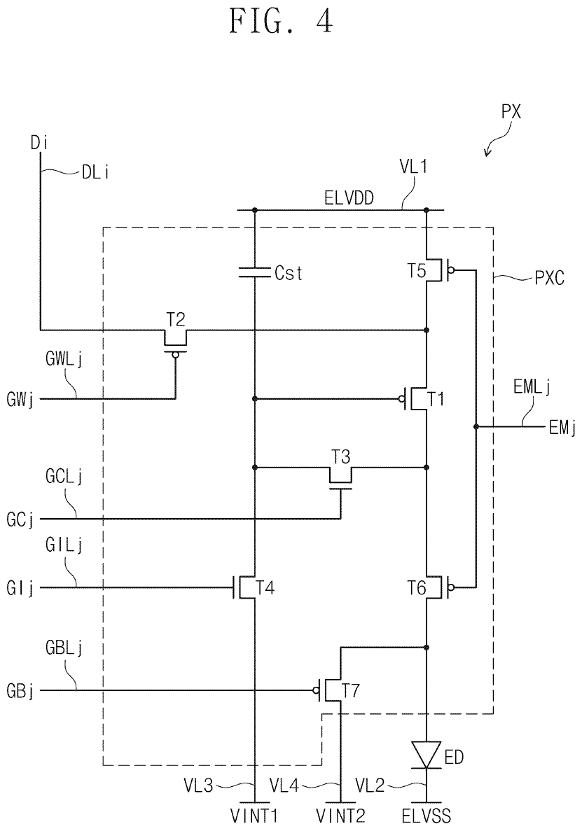

Each of the plurality of pixels PX includes a light-emitting element ED (see FIG. 4) and a pixel circuit PXC (see FIG. 4) controlling light emission of the light-emitting element. The pixel circuit PXC may include one or more transistors and one or more capacitors. The scan driving circuit 300 and the light-emitting driver circuit 400 may include transistors formed through the same process as, or a similar process to, that by which the transistors in the pixel circuit PXC are formed.

Each of the plurality of pixels PX receives the first driving voltage ELVDD, the second driving voltage ELVSS, the first initialization voltage VINT1, and the second initialization voltage VInt2 from the voltage generator 500.

FIG. 4 is a circuit diagram of a pixel PX according to some example embodiments of the present disclosure.

FIG. 4 exemplarily illustrates the pixel PX connected to the i-th data line DLi among the data lines DL1-DLm, the j-th scan lines GILj, GCLj, GWLj, and GBLj among the scan lines GIL1-GILn, GCL1-GCLn, GWL1-GWLn, and GBL1-GBLn, and the j-th light emission control line EMLj among the light emission control lines EML1-EMLn illustrated in FIG. 3.

Each of the plurality of pixels PX illustrated in FIG. 3 may have the same circuit configuration as, or a similar circuit configuration to, that of the pixel PX illustrated in FIG. 4. The pixel PX according to some example embodiments includes the pixel circuit PXC and at least one light-emitting element ED. In some example embodiments, the light-emitting element ED may be an organic light-emitting diode. The pixel circuit PXC includes first to seventh transistors T1, T2, T3, T4, T5, T6, and T7 and a capacitor Cst.

In this example, the third and fourth transistors T3 and T4 among the first to seventh transistors T1 to T7 are N-type transistors having an oxide semiconductor as a semiconductor layer, and each of the first, second, fifth, sixth, and seventh transistors T1, T2, T5, T6, and T7 is a P-type transistor having a low-temperature polycrystalline silicon (LTPS) semiconductor layer. However, the present disclosure is not limited thereto. For example, all of the first to seventh transistors T1-T7 may be P-type transistors or N-type transistors. In some example embodiments, at least one of the first to seventh transistors T1-T7 may be an N-type transistor, and the rest may be a P-type transistor. Also, the circuit configuration of the pixel PX according to the present disclosure is not limited to FIG. 4. The pixel circuit PXC illustrated in FIG. 4 is only an example, and the configuration of the pixel circuit PXC may be modified.

The j-th scan lines GILj, GCLj, GWLj, and GBLj may respectively transmit the j-th scan signals GIj, GCj, GWj, and GBj. The light emission control line EMLj transmits a light emission signal EMj, and the i-th data line DLi transmits an i-th data signal Di. The data signal Di may have a voltage level corresponding to the input image signal RGB input to the display module DM (see FIG. 3). The first to fourth driving voltage lines V1, V2, V3, and V4 may transmit the first driving voltage ELVDD, the second driving voltage ELVSS, the first initialization voltage VINT1, and the second initialization voltage VInt2.

The first transistor T1 includes a first electrode connected to the first driving voltage line V1 via a fifth transistor T5, a second electrode electrically connected to an anode of the light-emitting element ED via a sixth transistor T6, and a gate electrode connected to one end of the capacitor Cst. The first transistor T1 may receive the data signal Di transmitted from the data line DLi according to the switching operation of the second transistor T2 to supply a driving current to the light-emitting element ED.

The second transistor T2 includes a first electrode connected to the data line DLi, a second electrode connected to the first electrode of the first transistor T1, and a gate electrode connected to the scan line GWLj. The second transistor T2 may be turned on according to the scan signal GWj transmitted through the scan line GWLj to transmit the data signal Di transmitted from the data line DLi to the first electrode of the first transistor T1.

The third transistor T3 includes a first electrode connected to the gate electrode of the first transistor T1, a second electrode connected to the second electrode of the first semiconductor transistor T1, and a gate electrode connected to the scan line GCLj. The third transistor T3 may be turned on according to the scan signal GCj received through the scan line GCLj to connect the gate electrode and the second electrode of the first transistor T1 each other, thereby diode-connecting the first transistor T1.

The fourth transistor T4 includes a first electrode connected to the gate electrode of the first transistor T1, a second electrode connected to the third driving voltage line V3 to which the first initialization voltage VINT1 is transmitted, and a gate electrode connected to the scan line GILj. The fourth transistor T4 may be turned on according to the scan signal GIj received through the scan line GILj to transmit the first initialization voltage VINT1 to the gate electrode of the first transistor T1 to perform an initialization operation of initializing the voltage of the gate electrode of first transistor T1.

The fifth transistor T5 includes a first electrode connected to the first driving voltage line V1, a second electrode connected to the first electrode of the first transistor T1, and a gate electrode connected to the light emission control line EMLj.

The sixth transistor T6 includes a first electrode connected to the second electrode of the first transistor T1, a second electrode connected to the anode of the light-emitting element ED, and a gate electrode connected to the light emission control line EMLj.

The fifth transistor T5 and the sixth transistor T6 may be simultaneously (or contemporaneously) turned on according to the light emission signal EMj received through the light emission control line EMLj, and through this, the first driving voltage ELVDD may be compensated through the diode-connected first transistor T1 and transmitted to the light emitting element ED.

The seventh transistor T7 includes a first electrode connected to the second electrode of the sixth transistor T6, a second electrode connected to the fourth driving voltage line V4, and a gate electrode connected to the scan line GBLj. The seventh transistor T7 is turned on according to the scan signal GBj received through the scan line GBLj to bypass the current of the anode of the light-emitting element ED to the fourth driving voltage line V4.

One end of the capacitor Cst is connected to the gate electrode of the first transistor T1, and the opposite end of the capacitor Cst is connected to the first driving voltage line V1.

The light-emitting element ED is electrically connected to the second electrode of the first transistor T1 through the sixth transistor T6. A cathode of the light-emitting element ED may be connected to the second driving voltage line V2 that transmits the second driving voltage ELVSS. The structure of the pixel PX according to some example embodiments is not limited to the structure illustrated in FIG. 4, and the number of transistors, the number of capacitors, and the connection relationships included in the pixel PX may be variously modified. Also, the scan lines GWLj, GCLj, GILj, and GBj connected to the second, third, fourth, and seventh transistors T2, T3, T4, and T7 are merely examples, and may receive other scan signals. For example, the seventh transistor T7 may be connected to the scan line GCLj instead of the scan line GBLj.

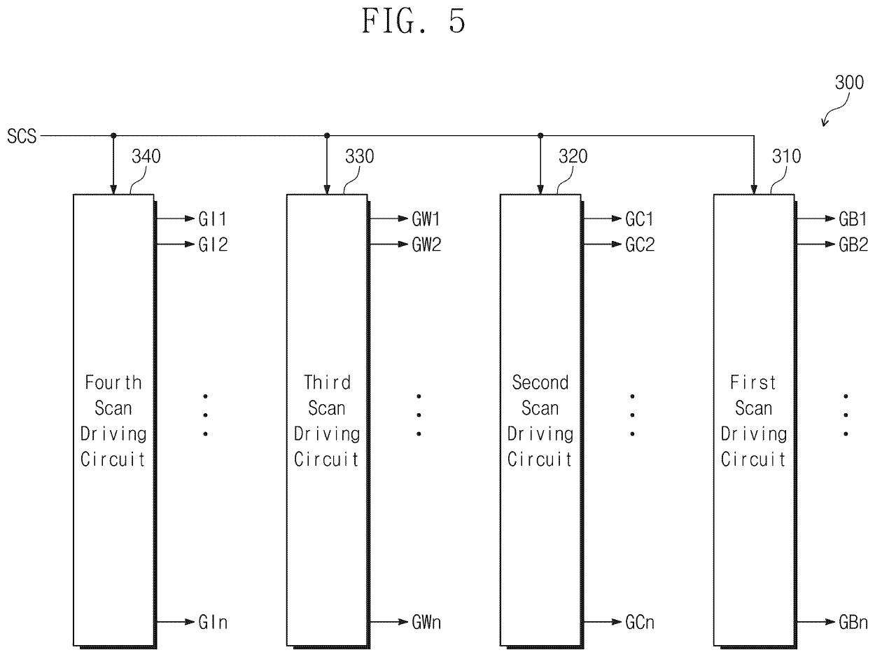

FIG. 5 is a block diagram exemplarily illustrating the scan driving circuit 300 in FIG. 3.

Referring to FIGS. 3 and 5, the scan driving circuit 300 includes a first scan driving circuit 310, a second scan driving circuit 320, a third scan driving circuit 330, and/or a fourth scan driving circuit 340.

The first scan driving circuit 310 outputs the scan signals GB1, GB2, . . . , GBn in response to the scan control signal SCS. The scan signals GB1, GB2, . . . , GBn may be provided to the scan lines GBL1-GBLn.

The second scan driving circuit 320 outputs the scan signals GC1, GC2, . . . , GCn in response to the scan control signal SCS. The scan signals GC1, GC2, . . . , GCn may be provided to the scan lines GCL1-GCLn.

The third scan driving circuit 330 outputs the scan signals GW1, GW2, . . . , GWn in response to the scan control signal SCS. The scan signals GW1, GW2, . . . , GWn may be provided to the scan lines GWL1-GWLn.

The fourth scan driving circuit 340 outputs the scan signals GI1, GI2, . . . , GIn in response to the scan control signal SCS. The scan signals GI1, GI2, . . . , GIn may be provided to the scan lines GIL1-GILn.

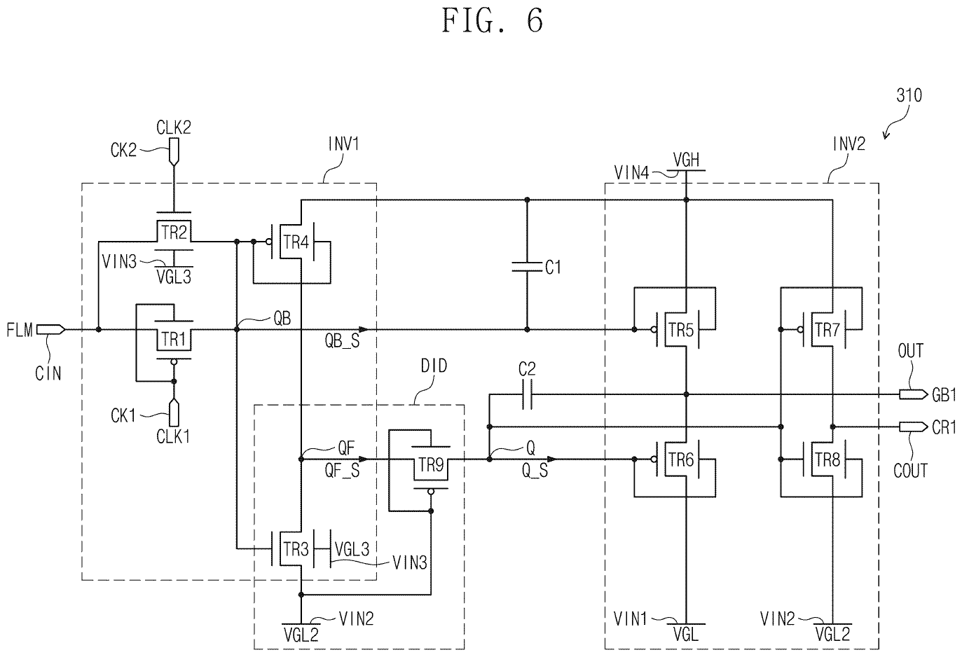

FIG. 6 is a circuit diagram of a first scan driving circuit 310 according to some example embodiments of the present disclosure.

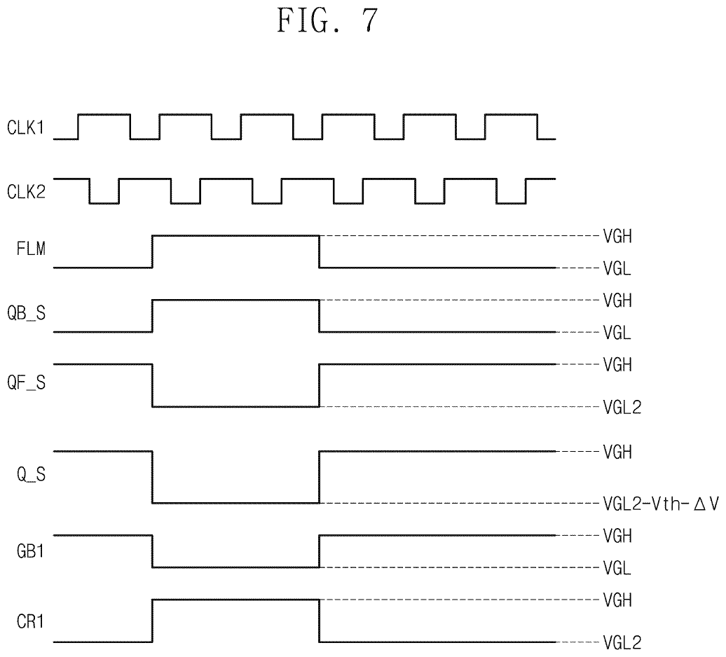

FIG. 7 is a timing diagram of signals used in the first scan driving circuit 310 illustrated in FIG. 6.

FIG. 6 exemplarily illustrates only a portion of the circuit configuration of the first scan driving circuit 310 that outputs the scan signal GB1. The first scan driving circuit 310 may further output the scan signals GB2 to GBn illustrated in FIG. 5 as well as the scan signal GB1. According to some example embodiments, each of the scan signals GB2 to GBn may be output by respective portions having the same circuit configuration as, or a similar circuit configuration to, that illustrated in FIG. 6.

Referring to FIGS. 6 and 7, the first scan driving circuit 310 outputs the scan signal GB1 and the carry output signal CR1 in response to the carry signal FLM, the first clock signal CLK1, and the second clock signal CLK2. The first scan driving circuit 310 includes first to ninth transistors TR1-TR9 and first and second capacitors C1, C2.

The first transistor TR1 is connected between the carry input terminal CIN and the QB node QB, and includes a gate electrode connected to the first clock terminal CK1.

The second transistor TR2 is connected between the carry input terminal CIN and the QB node QB, and includes a gate electrode connected to the second clock terminal CK2.

The third transistor TR3 is connected between the QF node QF and the second voltage terminal VIN2, and includes a gate electrode connected to the QB node QB.

The fourth transistor TR4 is connected between the fourth voltage terminal VIN4 and the QF node QF, and includes a gate electrode connected to the QB node QB.

The fifth transistor TR5 is connected between the fourth voltage terminal VIN4 and the output terminal OUT, and includes a gate electrode connected to the QB node QB.

The sixth transistor TR6 is connected between the output terminal OUT and the first voltage terminal VIN1, and includes a gate electrode connected to the Q node Q.

The seventh transistor TR7 is connected between the fourth voltage terminal VIN4 and the carry output terminal COUT, and includes a gate electrode connected to the Q node Q.

The eighth transistor TR8 is connected between the carry output terminal COUT and the second voltage terminal VIN2, and includes a gate electrode connected to the Q node Q.

The ninth transistor TR9 is connected between the QF node QF and the Q node Q and includes a gate electrode connected to the second voltage terminal VIN2.

The first capacitor C1 is connected between the fourth voltage terminal VIN4 and the QB node QB. The second capacitor C2 is connected between the Q node Q and the output terminal OUT.

In some example embodiments, the second, third, and eighth transistors TR2, TR3, and TR8 among the first to ninth transistors TR1-TR9 are N-type transistors having an oxide semiconductor as a semiconductor layer, and each of the first, fourth, fifth, sixth, seventh, and ninth transistors TR1, TR4, TR5, TR6, TR7, and TR9 is a P-type transistor having an LTPS semiconductor layer. However, the present disclosure is not limited thereto. The circuit configuration of the first scan driving circuit 310 of the present disclosure is not limited to that illustrated in FIG. 6. The first scan driving circuit 310 illustrated in FIG. 6 is only for an example, and the circuit configuration of the first scan driving circuit 310 may be modified.

In some example embodiments, each of the first to ninth transistors TR1-TR9 may include a double gate structure including a gate electrode (or an upper gate electrode) and a lower gate electrode. In some example embodiments, a gate electrode of each of the first, fourth, fifth, sixth, seventh, eighth, and ninth transistors TR1, TR4, TR6, TR7, TR8, and TR9 may be electrically connected to a lower gate electrode of the same transistor (or similar transistors).

In some example embodiments, a lower gate electrode of each of the second and third transistors TR2 and TR3 may be connected to the third voltage terminal VIN3. The third voltage terminal VIN3 receives the third voltage VGL3.

In some example embodiments, the QB node QB, the QF node QF and the Q node Q may be referred to as a first node QB, a second node QF and a third node Q, respectively.

Although FIG. 6 illustrates and describes that each of the first to ninth transistors TR1-TR9 includes a lower gate electrode, the present disclosure is not limited thereto. In some example embodiments, at least one of the first to ninth transistors TR1-TR9 may not include a lower gate electrode. In addition, a lower gate electrode of each of the first, fourth, fifth, sixth, seventh, eighth, and ninth transistors TR1, TR4, TR6, TR7, TR8, and TR9 may be electrically connected to a separate voltage terminal without being connected to the gate electrode of the same transistor (or similar transistors).

The carry input terminal CIN receives the carry signal FLM (may also be referred to herein as the carry input signal). The first clock terminal CK1 and the second clock terminal CK2 receive a first clock signal CLK1 and a second clock signal CLK2, respectively. In some example embodiments, the first clock signal CLK1 and the second clock signal CLK2 are signals complementary to each other.

The first, second, third, and fourth voltage terminals VIN1, VIN2, VIN3, and VIN4 may receive the first, second, third, and fourth voltages VGL, VGL2, VGL3, and VGH, respectively. In some example embodiments, the second voltage VGL2 may have a lower voltage level than the first voltage VGL. In some example embodiments, the fourth voltage VGH may be a voltage sufficient to turn off the seventh transistor T7 illustrated in FIG. 3. In some example embodiments, the first voltage VGL may be a voltage sufficient to turn on the seventh transistor T7 illustrated in FIG. 3.

In some example embodiments, the carry signal FLM may be a pulse signal that swings between the first voltage VGL and the fourth voltage VGH. In some example embodiments, the scan signal GB1 may be a pulse signal swinging between the first voltage VGL and the fourth voltage VGH. In some example embodiments, the carry output signal CR1 may be a pulse signal that swings between the second voltage VGL2 and the fourth voltage VGH. In some example embodiments, the scan signal GB1 and the carry output signal CR1 are complementary signals to each other.

In some example embodiments, the first transistor TR1, the second transistor TR2, the third transistor TR3, and the fourth transistor TR4 may configure the first inverter circuit INV1. The first inverter circuit INV1 may output, to the QF node QF, the second signal QF_S obtained by inverting the carry signal FLM in response to the carry signal FLM, the first clock signal CLK1, and the second clock signal CLK2. For example, when the carry signal FLM transitions from the low level to the high level, the second signal QF_S transitions from the high level to the low level.

Specifically, when the first clock signal CLK1 is at a low level, the first transistor TR1 is turned on. Since the second clock signal CLK2 is at a high level while the first clock signal CLK1 is at a low level, the second transistor TR2 is also turned on. In a state where both the first transistor TR1 and the second transistor TR2 are turned on, the first signal QB_S of the QB node QB is set to a high level the same as (or similar to) the carry signal FLM (e.g., the QB node BQ is set to the high level when the carry signal FLM is set to the high level). As the first signal QB_S is at a high level, the third transistor TR3 is turned on, and the second signal QF_S of the QF node QF becomes the same voltage level as (or a similar voltage level to) the second voltage VGL2 (e.g., the low level). While the first signal QB_S is at a high level, the fourth transistor TR4 is maintained in a turned-off state.

In this way, when the carry signal FLM transitions from the low level to the high level, the first inverter circuit INV1 transitions the second signal QF_S from the high level to the low level. At this time, the second signal QF_S has the same voltage level as (or a similar voltage level to) the second voltage VGL2.

Since the gate electrode of the ninth transistor TR9 is provided with the second voltage VGL2, the ninth transistor TR9 is maintained in a turned-on state. Therefore, the second signal QF_S of the QF node QF is transmitted to the Q node Q to obtain the third signal Q_S. The third signal Q_S at the Q node Q has a voltage level ‘VGL2−Vth’ that is lowered by the threshold voltage ‘Vth’ of the ninth transistor TR9 from the second voltage VGL2 of the second signal QF_S.

When the third signal Q_S of the Q node Q is at the voltage level VGL2−Vth, that is, at the low level, the sixth transistor TR6 is turned on. As the sixth transistor TR6 is turned on, the first voltage VGL is transferred to the output node OUT through the sixth transistor TR6. As a result, the scan signal GB1 may transition to a low level corresponding to the first voltage VGL. At this time, as the voltage of the output node OUT is lowered from the fourth voltage VGH to the first voltage VGL, the voltage of the Q node Q is lowered by the amount of change in the voltage of the output node OUT, that is, “VGH−VGL” by the second capacitor C2. ‘VGH−VGL’ is denoted as ‘ΔV’. That is, the voltage level of the third signal Q_S is ‘VGL2−Vth−ΔV’.

Since the voltage level of the third signal Q_S of the Q node Q is ‘VGL2−Vth−ΔV’ lower than the second voltage VGL2, the sixth transistor T6 may be sufficiently turned on (e.g., the voltage at the gate of the sixth transistor T6 is sufficiently low to turn on the sixth transistor T6). As a result, the scan signal GB1 output to the output terminal OUT may be quickly and stably maintained at the voltage level of the first voltage VGL.

The third transistor TR3 and the ninth transistor TR9 may configure the diode circuit DID. In a state where the third transistor TR3 is turned on, the ninth transistor TR9 has a diode structure in which the first electrode and the gate electrode are connected through the third transistor TR3. As a result, the second voltage VGL2 may be sufficiently transferred to the Q node Q by minimizing (or reducing) the voltage loss through the ninth transistor TR9 (e.g., such a diode configuration minimizes or reduces the voltage loss, for example, Vth, across the ninth transistor TR9).

The fifth, sixth, seventh, and eighth transistors TR5, TR6, TR7, and TR8 may configure the second inverter circuit INV2.

The second inverter circuit INV2 outputs the scan signal GB1 and the carry output signal CR1 in response to the third signal Q_S of the Q node Q. When the third signal Q_S of the Q node Q is at the low level, the second inverter circuit INV2 outputs the scan signal GB1 at the low level. When the third signal Q_S of the Q node Q is at the low level, the second inverter circuit INV2 outputs the carry output signal CR1 at the high level. Here, the scan signal GB1 and the carry output signal CR1 output from the second inverter circuit INV2 are complementary signals.

Specifically, the operation of the second inverter circuit INV2 will be described as follows. When the third signal Q_S of the Q node Q is at a voltage level lower than the second voltage VGL2, that is, at a low level, the sixth transistor TR6 is turned on and the scan signal GB1 transitions to the voltage level of the first voltage VGL, that is, to the low level. At this time, since the first signal QB_S of the QB node QB is at a high level, the fifth transistor TR5 is turned off. Therefore, the scan signal GB1 may be maintained at a low level.

When the third signal Q_S of the Q node Q is at a voltage level lower than the second voltage VGL2, that is, at a low level, the seventh transistor TR7 is turned on. As a result, the fourth voltage VGH is transmitted to the carry output terminal COUT through the seventh transistor TR7, so that the carry output signal CR1 becomes a high level.

The operation of the first scan driving circuit 310 when the carry signal FLM transitions from the high level to the low level is as follows.

When the carry signal FLM transitions from the high level to the low level and the first clock signal CLK1 is at the low level, the first signal QB_S of the QB node QB becomes at the low level through the first transistor TR1 in the turned-on state in the same manner as (or a similar manner to) the carry signal FLM (e.g., the first signal QB_S transitions to the same level as, or a similar level to, that of the carry signal FLM). When the first signal QB_S of the QB node QB is at a low level, the fifth transistor TR5 is turned on and the fourth voltage VGH is transmitted to the output terminal OUT. Therefore, the scan signal GB1 of the output terminal OUT is at a high level.

On the other hand, the third transistor TR3 is turned off and the fourth transistor TR4 is turned on as the first signal QB_S of the QB node QB becomes the low level. As the fourth transistor TR4 is turned on, the fourth voltage VGH is transferred to the QF node QF through the fourth transistor TR4.

When the second signal QF_S of the QF node QF is at a high level, the third signal Q_S of the Q node Q is also at a high level through the ninth transistor TR9. When the third signal Q_S is at a high level, the sixth transistor TR6 and the seventh transistor TR7 are respectively turned off, and the eighth transistor TR8 is turned on. As the eighth transistor TR8 is turned on, the carry output signal CR1 becomes the second voltage VGL2, that is, a low level. Here, since the eighth transistor TR8 is an N-type transistor having a fast response speed, the carry output signal CR1 may quickly transition to the second voltage VGL2, that is, a low level.

The ninth transistor TR9 is a P-type transistor. In general, a threshold voltage of a P-type transistor may be negatively shifted for a variety of reasons. When the threshold voltage is negatively shifted, the voltage transferred from the QF node QF to the Q node Q by the shifted threshold voltage may be lost. For example, during a clock cycle in which the voltage is transferred to the Q node Q, the voltage may not be sufficiently low to activate the sixth transistor TR6 (promptly or at all), resulting in a failure to output (or delay in outputting) the first voltage VGL to the output terminal OUT via the sixth transistor TR6. In this case, a delay may occur in changing the voltage of the Q node Q from the high level to the low level. This delay makes it difficult to sufficiently turn on the sixth transistor TR6. As a result, it is possible to delay the change of the scan signal GB1 of the output terminal OUT from the high level to the low level. According to some example embodiments, the delay in changing the scan signal GB1 may result in degradation of the quality of the image displayed on the electronic device.

In some example embodiments of the present disclosure, one end of the third transistor TR3 is connected to the second voltage terminal VIN2. The second voltage VGL2 provided to the second voltage terminal VIN2 has a lower voltage level than the first voltage VGL. Therefore, even if the threshold voltage of the ninth transistor TR9 is negatively shifted, a sufficiently low second voltage VGL2 may be transmitted to the Q node Q so as not to affect turning on the sixth transistor TR6. For example, even if the threshold voltage of the ninth transistor TR9 is negatively shifted, the voltage transferred to the Q node Q is still sufficiently low to activate the sixth transistor TR6, thereby avoiding or reducing the delay in changing the scan signal GB1 of the output terminal OUT from the high level to the low level, and thus, avoiding or reducing the degradation of the quality of the image displayed on the electronic device.

Furthermore, the second voltage VGL2 may be sufficiently transferred to the Q node Q by minimizing (or reducing) the voltage loss through the ninth transistor TR9 by the diode connection structure of the third transistor TR3 and the ninth transistor TR9. Accordingly, the diode connection structure may further ensure (or increase the likelihood that) the voltage transferred to the Q node Q is sufficiently low to activate the sixth transistor TR6, thereby avoiding or reducing the delay in changing the scan signal GB1 of the output terminal OUT from the high level to the low level, and thus, avoiding or reducing the degradation of the quality of the image displayed on the electronic device.

In some example embodiments, each of the second scan driving circuit 320, the third scan driving circuit 330, and the fourth scan driving circuit 340 shown in FIG. 5 may include a circuit configuration similar to that of the first scan driving circuit 310 in FIG. 6.

In some example embodiments, the second scan driving circuit 320 outputs scan signals GC1, GC2, . . . , GCn whose active levels are high levels, and the fourth scan driving circuit 340 outputs scan signals GI1, GI2, . . . , GIn whose active levels are high levels. An active level of the carry signal FLM input to each of the second scan driving circuit 320 and the fourth scan driving circuit 340 may be a low level. As a result, the scan signals GC1, GC2, . . . , GCn output from the second scan driving circuit 320 and the scan signals GI1, GI2, . . . , or GIn output from the fourth scan driving circuit 340 may have an active level at a high level.

In some example embodiments, the light-emitting driving circuit 400 shown in FIG. 3 may include a circuit configuration similar to that of the first scan driving circuit 310 in FIG. 6.

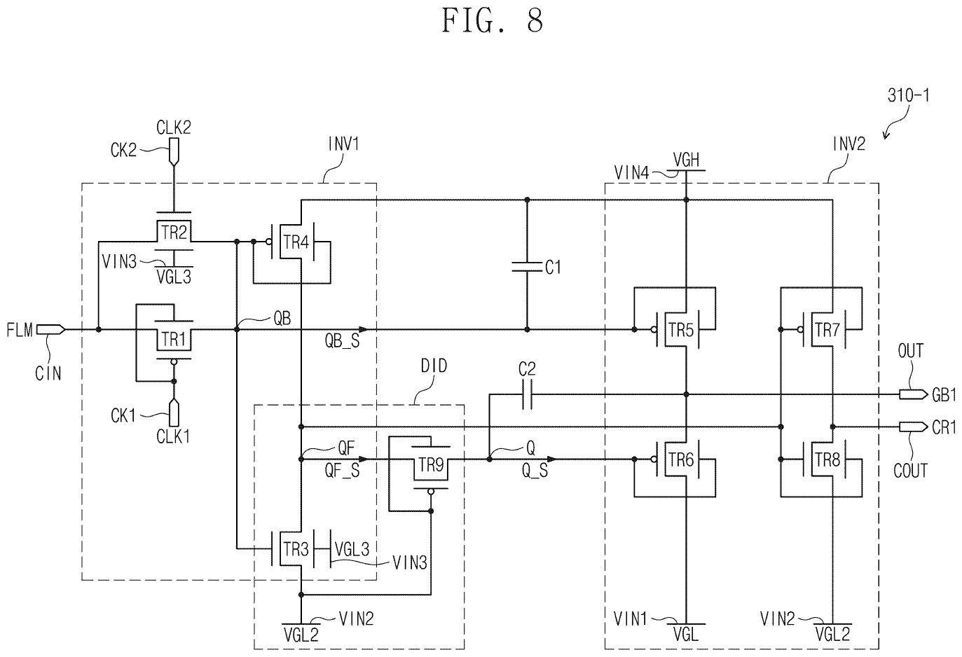

FIG. 8 is a diagram exemplarily illustrating a first scan driving circuit 310-1 according to some example embodiments of the present disclosure.

Components of the first scan driving circuit 310-1 illustrated in FIG. 8 that are similar to those of the first scan driving circuit 310 illustrated in FIG. 6 are denoted by the same reference numerals (or similar reference numerals) and redundant descriptions thereof are omitted.

Referring to FIGS. 7 and 8, the first scan driving circuit 310-1 outputs the scan signal GB1 and the carry output signal CR1 in response to the carry signal FLM, the first clock signal CLK1, and the second clock signal CLK2.

The seventh transistor TR7 is connected between the fourth voltage terminal VIN4 and the carry output terminal COUT, and includes a gate electrode connected to the QF node QF.

The eighth transistor TR8 is connected between the carry output terminal COUT and the second voltage terminal VIN2, and includes a gate electrode connected to the QF node QF.

A gate electrode of each of the seventh transistor TR7 and the eighth transistor TR8 of the first scan driving circuit 310 illustrated in FIG. 6 is connected to the Q node Q. A gate electrode of each of the seventh transistor TR7 and the eighth transistor TR8 of the first scan driving circuit 310-1 illustrated in FIG. 8 is connected to the QF node QF.

While the ninth transistor TR9 is turned on, the QF node QF and the Q node Q have similar waveforms. Therefore, even if the gate electrodes of each of the seventh transistor TR7 and the eighth transistor TR8 of the first scan driving circuit 310-1 are connected to the QF node QF, the gate electrodes may operate in the same manner as (or a similar manner to) the gate electrodes of the seventh transistor TR7 and the gate electrode of the eighth transistor TR8 of the first scan driver circuit 310 shown in FIG. 6.

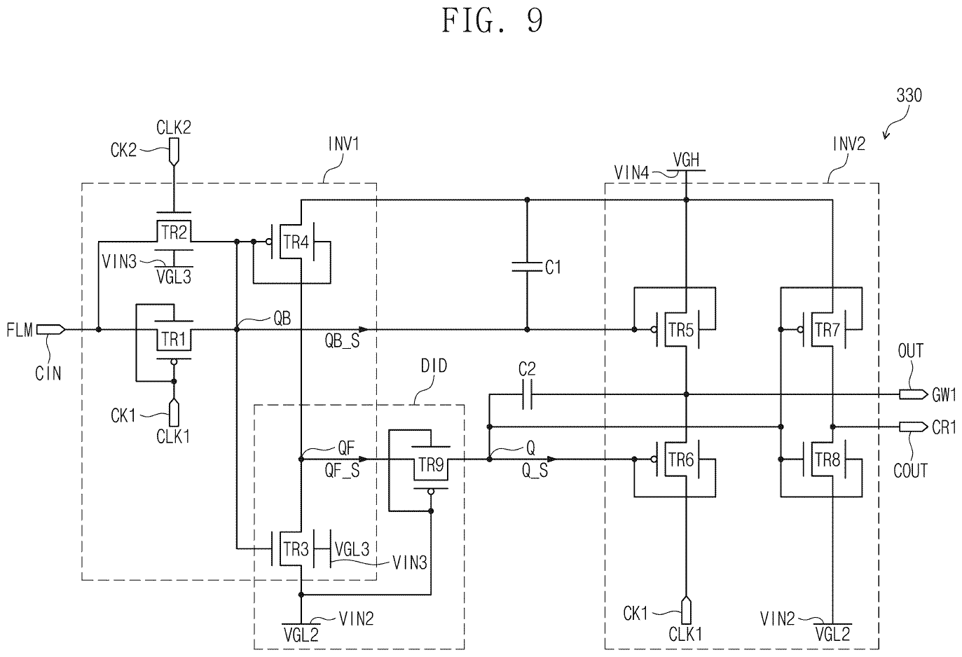

FIG. 9 is a diagram exemplarily showing a third scan driving circuit 330 according to some example embodiments of the present disclosure.

Components of the third scan driving circuit 330 illustrated in FIG. 9 that are similar to those of the first scan driving circuit 310 illustrated in FIG. 6 are denoted by the same reference numerals (or similar reference numerals) and redundant descriptions are omitted.

Referring to FIG. 9, the third scan driving circuit 330 outputs the scan signal GW1 and the carry output signal CR1 in response to the carry signal FLM, the first clock signal CLK1, and the second clock signal CLK2.

The sixth transistor TR6 is connected between the output terminal OUT and the first clock terminal CK1, and includes a gate electrode connected to the Q node Q.

When the third signal Q_S of the Q node Q is at the low level, the sixth transistor TR6 is turned on to transmit the first clock signal CLK1 from the first clock terminal CK1 to the output terminal OUT. For example, when the third signal Q_S of the Q node Q is at the low level and the first clock signal CLK1 is at the low-level, scan signal GW1 at a low level is output to the output terminal OUT. When the first clock signal CLK1 is at a high level when the third signal Q_S of the Q node Q is at a low level, scan signal GW1 at a high level is output to the output terminal OUT.

The low-level period of the first clock signal CLK1 corresponds to one horizontal period. One horizontal period is a time at which the data driving circuit 200 illustrated in FIG. 3 outputs the data signals D1-Dm to the pixels PX disposed in one row of the plurality of pixels PX.

When the third signal Q_S of the Q node Q is at a low level, the third scan driving circuit 330 may output the scan signal GW1 at the low level only while the first clock signal CLK1 is at the low level. Therefore, the third scan driving circuit 330 may output the low-level scan signal GW1 for a time corresponding to one horizontal period.

While the present disclosure has been described above with reference to some example embodiments thereof, it will be understood by those skilled in the art or those skilled in the relevant art that various modifications and changes may be made to the present disclosure without departing from the spirit and technical scope of the present disclosure as set forth in the following claims. Therefore, the technical scope of the present disclosure should not be limited to the contents described in the detailed description of the specification, but should be determined by the claims.

What is claimed is:

1. A scan driving circuit, comprising:
a first inverter circuit configured to,
output a first signal to a first node in response to a carry input signal, a first clock signal and a second clock signal, and
output a second signal to a second node, the second signal being obtained by inverting the carry input signal;
a diode circuit configured to transmit the second signal of the second node to a third node in response to the first signal of the first node; and
a second inverter circuit configured to output a scan signal and a carry output signal in response to a third signal of the third node, the scan signal and the carry output signal being complementary signals.

2. The scan driving circuit of claim 1, wherein the diode circuit includes:
a first transistor connected between the second node and a first voltage terminal, the first transistor including a gate electrode connected to the first node; and
a second transistor connected between the second node and the third node, the second transistor including a gate electrode connected to the first voltage terminal.

3. The scan driving circuit of claim 2, wherein the first transistor is an N-type transistor and the second transistor is a P-type transistor.

4. The scan driving circuit of claim 1, wherein the first inverter circuit includes:
a first transistor connected between a carry input terminal and the first node, the first transistor including a gate electrode connected to a first clock terminal, the first clock terminal configured to receive the first clock signal, and the carry input terminal is configured to receive the carry input signal;
a second transistor connected between the carry input terminal and the first node, the second transistor including a gate electrode connected to a second clock terminal configured to receive the second clock signal;
a third transistor connected between the second node and a first voltage terminal, the third transistor including a gate electrode connected to the first node; and
a fourth transistor connected between a second voltage terminal and the second node, the fourth transistor including a gate electrode connected to the first node.

5. The scan driving circuit of claim 4, wherein the first clock signal and the second clock signal are complementary signals.

6. The scan driving circuit of claim 4, wherein
each of the second transistor and the third transistor is an N-type transistor; and
each of the first transistor and the fourth transistor is a P-type transistor.

7. The scan driving circuit of claim 1, wherein the second inverter circuit includes:
a first transistor connected between a first voltage terminal and an output terminal, the first transistor including a gate electrode connected to the first node, and the output terminal being configured to output the scan signal;
a second transistor connected between the output terminal and a second voltage terminal, the second transistor including a gate electrode connected to the third node;
a third transistor connected between the first voltage terminal and a carry output terminal, the third transistor including a gate electrode connected to the third node, and the carry output terminal being configured to output the carry output signal; and
a fourth transistor connected between the carry output terminal and a third voltage terminal, the fourth transistor including a gate electrode connected to the third node.

8. The scan driving circuit of claim 7, wherein
each of the first transistor, the second transistor and the third transistor is a P-type transistor; and
the fourth transistor is an N-type transistor.

9. The scan driving circuit of claim 1, wherein the second inverter circuit includes:
a first transistor connected between a first voltage terminal and an output terminal, the first transistor including a gate electrode connected to the first node, and the output terminal being configured to output the scan signal;
a second transistor connected between the output terminal and a second voltage terminal, the second transistor including a gate electrode connected to the third node;
a third transistor connected between the first voltage terminal and a carry output terminal, the third transistor including a gate electrode connected to the second node, and the carry output signal being configured to output the carry output signal; and
a fourth transistor connected between the carry output terminal and a third voltage terminal, the fourth transistor including a gate electrode connected to the second node.

10. The scan driving circuit of claim 9, wherein
each of the first transistor, the second transistor and the third transistor is a P-type transistor; and
the fourth transistor is an N-type transistor.

11. The scan driving circuit of claim 1, wherein the second inverter circuit includes:
a first transistor connected between a first voltage terminal and an output terminal, the first transistor including a gate electrode connected to the first node, and the output terminal being configured to output the scan signal;
a second transistor connected between the output terminal and a first clock terminal, the second transistor including a gate electrode connected to the third node, and the first clock terminal being configured to receive the first clock signal;
a third transistor connected between the first voltage terminal and a carry output terminal, the third transistor including a gate electrode connected to the third node, and the carry output terminal being configured to output the carry output signal; and
a fourth transistor connected between the carry output terminal and a second voltage terminal, the fourth transistor including a gate electrode connected to the third node.

12. The scan driving circuit of claim 11, wherein
each of the first transistor, the second transistor and the third transistor is a P-type transistor; and
the fourth transistor is an N-type transistor.

13. An electronic device, comprising:
a display module configured to display an image; and
processing circuitry configured to transmit an electrical signal to the display module, the display module including,
a display panel including pixels connected to a scan line, and
a scan driving circuit configured to output a scan signal to the scan line in response to a carry input signal, a first clock signal and a second clock signal, the scan driving circuit including,
a first inverter circuit configured to,
output a first signal to a first node in response to the carry input signal, the first clock signal and the second clock signal, and
output a second signal to a second node, the second signal being obtained by inverting the carry input signal,
a diode circuit configured to transmit the second signal of the second node to a third node in response to the first signal of the first node, and
a second inverter circuit configured to output the scan signal in response to a third signal of the third node, the carry input signal and the scan signal being complementary signals.

14. The electronic device of claim 13, wherein the diode circuit includes:
a first transistor connected between the second node and a first voltage terminal, the first transistor including a gate electrode connected to the first node; and
a second transistor connected between the second node and the third node, the second transistor including a gate electrode connected to the first voltage terminal.

15. The electronic device of claim 14, wherein the first transistor is an N-type transistor and the second transistor is a P-type transistor.

16. The electronic device of claim 13, wherein the first inverter circuit includes:
a first transistor connected between a carry input terminal and the first node, the first transistor including a gate electrode connected to a first clock terminal, the carry input terminal being configured to receive the carry input signal, and the first clock terminal being configured to receive the first clock signal;
a second transistor connected between the carry input terminal and the first node, the second transistor including a gate electrode connected to a second clock terminal configured to receive the second clock signal;
a third transistor connected between the second node and a first voltage terminal, the third transistor including a gate electrode connected to the first node; and
a fourth transistor connected between a second voltage terminal and the second node, the fourth transistor including a gate electrode connected to the first node.

17. The electronic device of claim 13, wherein the second inverter circuit includes:
a first transistor connected between a first voltage terminal and an output terminal, the first transistor including a gate electrode connected to the first node, and the output terminal being configured to output the scan signal; and
a second transistor connected between the output terminal and a second voltage terminal, the second transistor including a gate electrode connected to the third node.

18. The electronic device of claim 17, wherein the second inverter circuit includes:
a third transistor connected between the first voltage terminal and a carry output terminal, the third transistor including a gate electrode connected to the third node, and the carry output terminal being configured to output a carry output signal; and
a fourth transistor connected between the carry output terminal and a third voltage terminal, the fourth transistor including a gate electrode connected to the third node.

19. The electronic device of claim 13, wherein the second inverter circuit includes:
a first transistor connected between a first voltage terminal and an output terminal, the first transistor including a gate electrode connected to the first node, and the output terminal being configured to output the scan signal;
a second transistor connected between the output terminal and a second voltage terminal, the second transistor including a gate electrode connected to the third node;
a third transistor connected between the first voltage terminal and a carry output terminal, the third transistor including a gate electrode connected to the second node, and the carry output terminal being configured to output a carry output signal; and
a fourth transistor connected between the carry output terminal and a third voltage terminal, the fourth transistor including a gate electrode connected to the second node.

20. The electronic device of claim 13, wherein: the second inverter circuit includes:
a first transistor connected between a first voltage terminal and an output terminal, the first transistor including a gate electrode connected to the first node, and the output terminal being configured to output the scan signal;
a second transistor connected between the output terminal and a first clock terminal, the second transistor including a gate electrode connected to the third node, and the first clock terminal being configured to receive the first clock signal;
a third transistor connected between the first voltage terminal and a carry output terminal, the third transistor including a gate electrode connected to the third node, and the carry output terminal being configured to output a carry output signal; and
a fourth transistor connected between the carry output terminal and a second voltage terminal, the fourth transistor including a gate electrode connected to the third node.
